(19) United States
(12) Patent Application Publication
(10) Pub. No.: US 2008/0210062 A1
(43) Pub. Date: Sep. 4, 2008

(54) Ratcheting manual threader drive device

(75) Inventors: Craig J. Nitchman, Wakeman, OH (US); James Thayer, (US)

Correspondence Address: RANKIN, HILL & CLARK LLP, 38210 Glenn Avenue, WILLOUGHBY, OH, 44094-7808, US

(73) Assignee: Emerson Electric Co.

(21) Appl. No.: 11/712,723

(22) Filed: Mar. 1, 2007

(51) Int. Cl. B25B 13/22

(52) U.S. Cl. 81/58

(57) ABSTRACT

A ratchet assembly, and particularly, a ratcheting manual threader drive device is described. The device utilizes a unique pawl extension assembly that includes a sleeve, and one or more biasing members that are positioned within a channel extending through the head of the assembly.

### BACKGROUND

Manual threaders, and specifically, ratcheting hand threaders, are used in a variety of applications to form a thread on the end of a pipe, bolt or conduit. Once formed, the threaded end can then be engaged with other threaded components such as fasteners, couplings or valves, or additional sections of pipes or conduits.

Ratcheting hand threaders typically include a ratchet assembly, a ratchet handle, and removable die heads that can be selectively engaged with the ratchet assembly to cut the desired threads into the pipe or conduit of interest.

Ratcheting manual threaders are generally either “enclosed” or “exposed.” These terms refer to whether the ratchet mechanism is enclosed or exposed. Typically, when using relatively small die heads, the ratchet mechanism is enclosed by a centrally disposed engagement member. An adapter fits within this member and in turn, engages and retains a die head. In the exposed configuration, a die head having a ratchet ring member and a collection of outwardly projecting splines or teeth is used in conjunction with a corresponding ratchet head. The ratchet splines are engaged by a pawl retained in the ratchet head, when the ratchet ring (of the die head) is positioned within the ratchet head.

A user wishing to form a threaded pipe end for example, with a ratcheting threader, first selects the appropriate die head to use. Die heads vary by the diameter of pipe or conduit for which the die head is used, the size and configuration of the thread, and type of material of the pipe, which in turn can dictate the particular die head to be used.

The selected die head is then engaged with the ratchet assembly. Depending upon whether the ratchet is of the enclosed or exposed type, the die head is used with an adapter (if the ratchet is enclosed) or is provided with a ratchet ring member (if the ratchet is exposed) and engaged with a ratchet head. The resulting assembly can then be used as desired.

When assembling an exposed ratchet assembly, the pawl is pulled back to retract the pawl tip from an interior receiving region of the ratchet head. This enables the ratchet ring member (of the die head) to be positioned within the ratchet head. After the ring member has been appropriately positioned, the pawl is released and urged into engagement with a series of splines along the outer periphery of the ring member by a spring.

Although currently known ratchet assemblies are often satisfactory, there is a need for an improved ratchet assembly.

### SUMMARY

In a first aspect, the present invention provides a ratcheting threader drive device comprising a ratchet head that includes a body which defines a neck, a pawl receiving member, an outer surface and an inner circumferential surface. The inner surface defines a hollow interior. The pawl receiving member defines an access aperture extending between the outer surface and the inner surface of the ratchet head. The ratcheting threader drive device also comprises a ratchet ring including a collection of outwardly extending splines disposed along the circumference of the ring. The ring and collection of splines are sized to fit within the hollow interior of the ratchet head. The ratcheting threader drive device also comprises a pawl assembly including a pawl having a distal tip adapted to engage the splines of the ratchet ring, at least one biasing member, and a knob engaged to an end region of the pawl opposite the distal tip. The pawl assembly is at least partially disposed in the access aperture of the pawl receiving member. The ratcheting threader drive device also comprises a sleeve disposed within the access aperture and defining a longitudinal channel through which the pawl extends. The sleeve is disposed between the pawl and the access aperture defined in the pawl receiving member.

In another aspect, the present invention provides a ratcheting threader drive assembly comprising a ratchet head having a body that defines a neck, a pawl receiving member, an outer surface, and an inner circumferential surface. The inner surface of the ratchet head body defines a hollow region. The pawl receiving member defines an access aperture extending between the outer surface and the inner surface of the ratchet head body. The ratchet head also has a handle engaged with the neck of the body. The ratcheting threader drive assembly also comprises a die head having a ratchet ring including a collection of outwardly projecting splines. The splines are arranged in a row around the periphery of the ratchet ring. The ring and collection of splines are adapted to fit within the hollow region of the ratchet head. The ratcheting threader drive assembly also comprises a pawl assembly including a cylindrically shaped pawl having a distal end for engaging the collection of splines of the ratchet ring, at least one biasing member, and a gripping member attached at an end of the pawl opposite the distal end. The pawl assembly is slidably disposed in the access aperture defined in the pawl receiving member of the ratchet head. The ratcheting threader drive assembly further comprises a sleeve having a first end, a second end opposite the first end, and an aperture extending between the first and second ends. The sleeve is disposed within the access aperture defined in the pawl receiving member and the pawl, extending through the aperture of the sleeve.

In yet another aspect, the present invention provides a ratcheting threader drive device comprising a ratchet head having a body that defines an outwardly extending neck, a pawl receiving member, an outer surface, and an inner surface defining a hollow interior of the body. The pawl receiving member defines an access aperture extending between the outer surface and the inner surface of the body. The ratcheting threader drive device also comprises a pawl slidably disposed in the access aperture defined in the pawl receiving member. And, the ratcheting threader drive device comprises a pawl extension assembly also disposed in the access aperture defined in the pawl receiving member. The pawl extension assembly includes a sleeve defining a longitudinal channel extending across the length of the sleeve, and at least one biasing member in contact with the sleeve. The pawl extends at least partially within the longitudinal channel of the sleeve.

In still a further aspect, the present invention provides a ratcheting threader drive comprising a ratchet head that defines an outer surface and an interior surface. The interior surface defines a generally hollow cylindrically shaped interior. The head also includes an outwardly projecting pawl receiving member. The head also defines an access aperture extending through the pawl receiving member to the interior of the ratchet head. The ratcheting threader drive also comprises a die head having a ratchet ring including a collection of splines extending about a circumferential region of the die head. The die head is sized and adapted to be positioned within the interior of the ratchet head. The ratcheting threader drive device also comprises a sleeve disposed in the access aperture defined in the ratchet head. The sleeve has a first end and a second end and defines a longitudinal channel extending between the first and second ends. The ratcheting threader drive also comprises a pawl slidably disposed in the access aperture defined in the ratchet head and extending within the longitudinal channel defined in the sleeve. The pawl has a distal tip that is adapted to extend into the interior of the ratchet head and between adjacent splines of the die head.

### BRIEF DESCRIPTION OF THE DRAWINGS

FIG. 1 is an exploded view of a conventional ratchet assembly.

FIG. 2 is an exploded view of a typical die head, die, and cover plate used in association with the ratchet assembly shown in FIG. 1.

FIG. 3 is an exploded view of a preferred embodiment ratchet head and pawl extension assembly.

FIG. 4 is a front elevational view of the ratchet head depicted in FIG. 3.

FIG. 5 is a side view of the ratchet head depicted in FIG. 3.

FIG. 6 is a perspective view of a preferred embodiment pawl.

FIG. 7 is a side view of the pawl shown in FIG. 6.

FIG. 8 is a perspective view of a preferred embodiment sleeve.

FIG. 9 is a side view of the sleeve illustrated in FIG. 8.

FIG. 10 is a perspective view of a preferred embodiment spring.

FIG. 11 is a perspective view of another preferred embodiment spring.

FIG. 12 is a perspective view of a preferred embodiment pawl extension assembly.

FIG. 13 is a planar top view of the ratchet assembly depicted in FIG. 3, in a partially assembled state.

FIG. 14 is a rear elevational view of the ratchet assembly in FIG. 3, opposite that of FIG. 4, in a partially assembled state.

FIG. 15 is a detailed partial cross-sectional view taken across the section line A-A in FIG. 13.

### DETAILED DESCRIPTION

The present invention relates to a ratchet assembly, and particularly a ratcheting manual threader drive, that utilizes a particular pawl extension assembly. The preferred embodiment pawl extension assembly can be incorporated and used in a conventional ratchet head. The present invention also provides various preferred embodiment ratchet heads that include the pawl extension assembly.

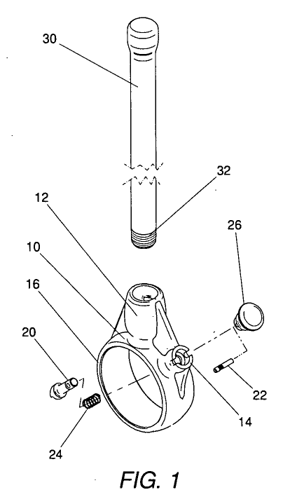

FIG. 1 is an exploded view of a conventional ratchet assembly as follows. The assembly includes a ratchet head 10, having an outwardly extending neck 12, and a pawl receiving member 14. An aperture or channel is defined within the pawl receiving member and provides access to the interior of the ratchet head 10. Defined on at least one face, and preferably both faces, of the ratchet head 10 is a circular ring seat 16. A cylindrically shaped pawl 20 is slidably disposed in the receiving member 14. The pawl 20 is disposed within a spring 24 or otherwise engaged therewith, positioned within the aperture or channel in the receiving member 14, and typically attached to a knob 26 positioned along the exterior of the head 10 to thereby retain the pawl 20 within the receiving member 14. Generally, a retaining pin 22 is inserted through an aperture defined in the pawl 20 and in the knob 26 to secure the knob 26 to the pawl 20 and assist in retaining the pawl 20 in a retracted position as described more fully herein. The pin 22 also indicates the drive state of the ratchet assembly. That is, the relative rotational orientation of the pawl 20 is indicated by the position of the pin 22. As will be appreciated, the orientation of the pawl 20 with respect to a die head, as explained herein, determines the drive state of the ratchet assembly. And thus, the position of the pin 22 indicates whether the ratchet can be driven in a clockwise or counter-clockwise direction. A handle 30 is used in conjunction with the ratchet head 10 and is preferably affixed to the neck member 12 by a threaded end region 32.

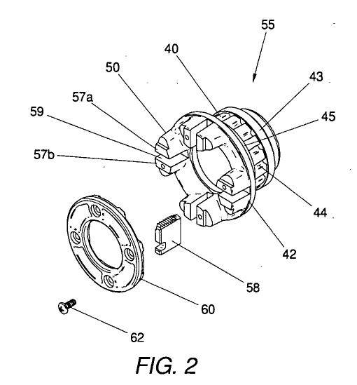

With reference to FIG. 2, a die head 55 is used in conjunction with the ratchet head 10 (FIG. 1) to form a working ratchet assembly. The die head 55 includes a ratchet ring 40 and a die receiving end 50. The ratchet ring 40 includes a cylindrical body having a plurality of outwardly extending splines 44 preferably disposed in a row-like arrangement about the outer circumference or periphery of the ratchet ring 40. The ratchet ring 40 also includes two circumferential races or piloting diameters, one on each side of the row of splines 44. Specifically, a first circumferential race 43 is defined adjacent the end region of the ratchet ring 40 and extends between the row of splines 44 and that end. And, a second circumferential race 45 is defined adjacent the other side of the row of splines 44 and extends between the row of splines 44 and a circular head seat 42 described below. The diameter of each of the circumferential races 43 and 45 is preferably the same. And, the diameter of the races 43 and 45 is preferably slightly greater than the maximum span of the row of splines 44 taken across the diameter of the ratchet ring 40. Typically, the ratchet ring 40, the splines 44, the races 43 and 45, and the die receiving end 50 are in the form of an integral component such as a single casting. Defined along a circumferential outer region adjacent to the circumferential race 45 is a circular head seat 42. One or more die(s) 58, i.e. the component that forms or “cuts” threads into the conduit or pipe of interest, are engaged with the die receiving end 50 and are retained thereon by a cover plate 60 and one or more fasteners 62. Preferably, the die(s) 58 are disposed between the die receiving end 50 and the cover plate 60. Typically, four dies are used, and each is disposed within a receiving slot 59 defined between two outwardly projecting members 57a and 57b along the die receiving end 50.

It will be appreciated that upon insertion and placement of the die head 55 within the generally open interior region of the ratchet head 10, the pawl 20 can be released and extended from its retracted position in the ratchet head 10 to extend between depressions defined between adjacent spline members 44. In this manner, the ratchet ring 40 and thus the die head 55 can be rotatably engaged with the ratchet head 10 when the pawl is extended between the splines 44. It will also be understood that the die head 55 can be inserted in either direction within the open interior region of the ratchet head 10. That is, the die receiving end 50 of the die head can face the same direction or in an opposite direction as the face of the head 10 shown in FIG. 1. The ratchet head assembly and ring assembly depicted in FIGS. 1 and 2, are an example of an exposed ratchet mechanism.

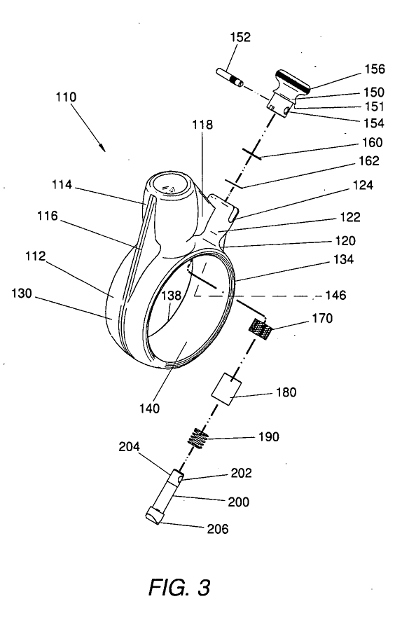

FIG. 3 illustrates a preferred embodiment ratchet head 110 and a preferred embodiment pawl extension assembly. The ratchet head 110 includes a body 112 including a neck 114 and a pawl receiving member 122. One or more strengthening members are preferably provided between the outwardly projecting body and neck member such as strengthening members 116, 118, and 120. A retention slot 124 is defined within the pawl receiving member and preferably across the width of that member. The retention slot 124 provides orientation for a pawl 200 when using the device, i.e. when forming threads. As explained in greater detail herein, upon extension of the pawl 200 into the interior of the ratchet head 110 for engagement between splines of a die head (not shown), the retention slot 124 promotes alignment and orientation of a tip 206 of the pawl 200 with respect to the splines of the die head. The top distal surface of the pawl receiving member 122 provides support for the pawl when retracted from the splines, such as when changing die heads. The body 112 of the ratchet head 110 defines an outer surface 130, an interior circumferential surface 140, a circular ring seat 134 and an oppositely directed circular rear region 138 extending between surfaces 130 and 140. A second circular ring seat can be provided on the opposite face of the ratchet head 110 within the rear region 138. Also defined within the body 112 of the ratchet head 110 is a pawl access aperture 146 (not shown in FIG. 3) which provides access to a pawl such as pawl 200 retained within the receiving member 122. The pawl access aperture 146 is preferably in the form of a cylindrical channel extending through the cylindrical wall of the ratchet head 110 and through the receiving member 122. As described in greater detail herein, the pawl access aperture 146 is sized and adapted to accommodate the pawl 200 and its related assembly. Upon positioning of pawl 200 within the receiving member 122, a knob 150 or other gripping member can be attached to the pawl 200. A pin 152 secures an end of the pawl 200 to the knob 150 by insertion through an aperture 154 defined in the knob 150 and an aperture 202 defined in the pawl 200. The pawl 200 also includes an angled tip region 206 described in greater detail herein. The knob 150 preferably defines an underside ledge 151. The knob 150 preferably also defines a serrated gripping region 156 around the outer periphery of the knob 150.

FIG. 3 also illustrates a preferred embodiment pawl extension assembly including the pawl 200, a sleeve 180, and one or more biasing members such as springs 170 and 190. In accordance with a preferred embodiment, the pawl 200 and spring 190 is inserted within the hollow cylindrical member or sleeve 180. The sleeve is appropriately positioned between springs 190 and 170. The pawl 200, sleeve 180, and springs 170, 190 are disposed within the pawl access aperture 146 defined in the receiving member 122 such that a head 204 of the pawl 200 is accessible through the slot 124 or along the top surface of the receiving member 122. This configuration allows pin 152 to be inserted therethrough and further engaged within the aperture 154 defined in the knob 150. As described in greater detail herein, a retaining ring 160 and a washer 162 can be disposed in the aperture 146.

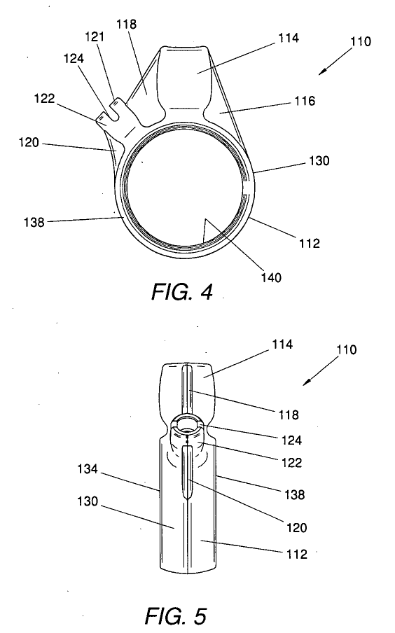

FIG. 4 illustrates a front view of the preferred embodiment ratchet head 110. This view illustrates the rear region 138 extending between the interior circumferential surface 140 and the outer surface 130. As previously noted, a circular ring seat may also be provided on the rear region 138 such that a die head (not shown) can be engaged with the ratchet head 110 along the rear region 138. FIG. 4 also illustrates a distal support ledge 121 defined along an outermost surface of the pawl receiving member 122.

FIG. 5 is a side view of the preferred embodiment ratchet head 110. The pawl receiving member 122 and the retention slot 124 are shown. The neck 114, which can receive a handle (not shown) extends generally radially outward from the body 112. Similarly, the pawl receiving member 122 also extends generally radially outward from the body, as shown in FIG. 4.

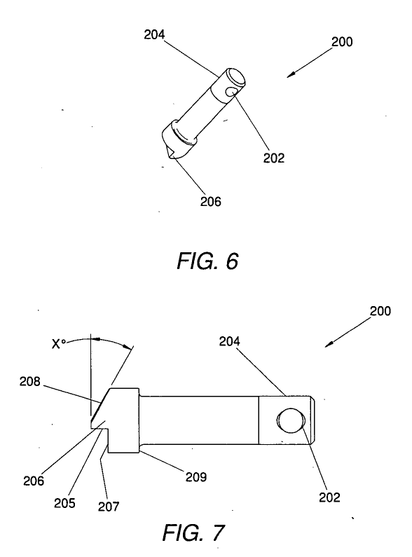

FIG. 6 is a perspective view of the pawl 200. As can be seen, pawl 200 includes an aperture 202 preferably extending through the body of pawl 200 along its head 204. An oppositely located tip 206 is defined at the other end of the pawl 200.

FIG. 7 is a side view of the pawl 200 further illustrating a preferred configuration for the tip region 206. The tip 206 preferably includes an angled surface 208 which, when the pawl 200 is engaged in an assembled ratchet assembly and upon ratcheting, contacts the splines 44 of the ratchet ring 40 of the die head 55, such as depicted in FIG. 2. Generally, the angled surface 208 extends at an angle X, taken transversely with respect to the longitudinal axis of the pawl 200. Angle X ranges from about 10° to 75°, preferably from about 20° to about 50°, and most preferably about 30°. The tip 206 of the pawl 200 also defines a drive surface 205 and a rest surface 207. Preferably, the surfaces 205 and 207 are perpendicular to each other, although other configurations are contemplated. Upon extension of the pawl 200 into the interior of the ratchet head and particularly, between adjacent splines 44 of the ratchet ring, the drive surface 205 contacts and engages a spline and can then serve to transfer a load to the die head. And thus, the drive surface 205 contacts the splines 44 upon “driving” or application of force by the ratchet assembly. In this extended state of the pawl 200, the pawl 200 is precluded from over extending between splines by rest surface 207. In its extended state, a distal most tip of a spline 44 contacts and supports the pawl 200 along the rest surface 207. As will be appreciated, while the pawl is in its extended or partially extended state, upon rotation of the ratchet head relative to the die head in a direction opposite that of the loading direction, the angled surface 208 of the pawl contacts an adjacent spline 44 and urges the pawl to retract from between adjacent splines until the die head has been sufficiently rotated to expose another free region between adjacent splines into which the pawl 200 is urged. A circular and outwardly extending seat surface 209 is defined about the circumference of the pawl 200, which also separates the tip 206 from the main cylindrical body of the pawl.

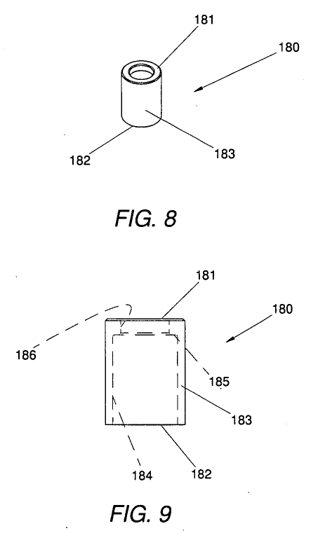

FIG. 8 is a perspective view of the preferred embodiment hollow cylindrical sleeve 180. The sleeve 180 defines a first end 181, a second end 182 opposite from the first end, and a circumferential wall 183 extending between the ends 181 and 182. The wall 183 defines a hollow interior also extending between the ends 181 and 182.

FIG. 9 is a side view of the preferred embodiment sleeve 180 illustrating in greater detail the preferred configuration for the interior of the sleeve 180. Defined along an interior region of the circumferential wall 183 is an interior face surface 184. The interior face surface 184 defines a longitudinal channel extending through the sleeve 180. The channel is sized to receive a pawl 200 and spring 190 positioned therein. Also defined along the first end 181 is a circular spring seat 185. As can be seen, the circular spring seat 185 is preferably defined adjacent the first end 181. The spring seat 185 generally extends between a circular aperture 186 and the interior face surface 184 of the sleeve 180. The aperture 186 is sized and shaped to accommodate the pawl 200 and its head 204, but not the enlarged tip region 206. The interior hollow region of the sleeve 180 defined by the interior face surface is sized and shaped to receive and accommodate the tip region 206 of the pawl 200.

Instead of the preferred embodiment sleeve 180 described herein, a wide array of other sleeve designs and configurations are contemplated. For example, sleeve or sleeve-like components having different shapes and/or cross-sectional configurations could be used. Sleeve-like components having only a portion of the body or characteristics of sleeve 180 could in certain applications be used. A sleeve component having one or more apertures or open regions along its side wall(s) is contemplated. A sleeve having a keyed configuration is also envisioned such that the sleeve maintains a particular desired orientation.

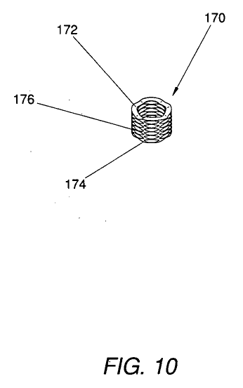

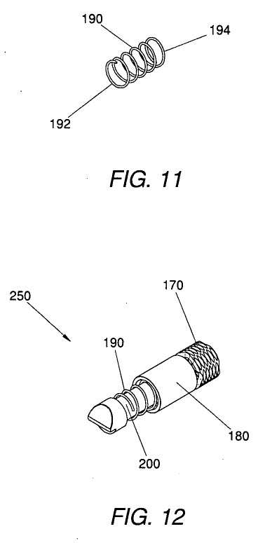

FIG. 10 is a perspective view of the preferred embodiment spring 170 used in the preferred embodiment pawl extension assembly. The spring 170 includes a first end 172, a second opposite end 174, and a spring body 176 extending between the first and second ends 172 and 174. The spring 170 defines a generally hollow interior that is accessible from both ends 172 and 174. The interior hollow region of the spring 170 is sized and shaped to receive and accommodate the head 204 of the pawl 200. The spring 170 as shown in FIGS. 3 and 10 can be similar to the spring 190 as depicted in FIG. 11, or as shown, can be in the form of a wave spring.

FIG. 11 is a perspective view of the spring 190 utilized in the preferred embodiment ratchet head and pawl extension assembly. The spring 190 defines a first end 192 and a second opposite end 194. Although the spring 190 is depicted as a coil spring, other spring configurations can be used. The spring 190 as shown in FIGS. 3 and 11 can be similar to the spring 170, or as shown, can be in the form of a coil spring.

The preferred embodiment pawl extension assembly includes the sleeve 180, and one or more biasing members or springs 170 and 190. Referring further to FIGS. 3, 7 and 9, preferably, the sleeve 180 is sized and configured such that the sleeve end 181 receives a portion of the spring 170 or abuttingly contacts the spring 170. The opposite end 182 of the sleeve 180 is preferably sized and configured to receive the spring 190, or at least a portion thereof. Preferably, the spring seat 185 defined within the interior of the sleeve 180 contacts an end of the spring 190 inserted therein. Preferably, the spring seat 185 serves as a support ledge for the spring 190. The sleeve 180 defines a hollow interior that also receives the previously noted pawl 200. Upon incorporation of the pawl extension assembly within a ratchet head, the seat surface 209 of the pawl contacts an end of the spring 190. An opposite end of the spring 190 contacts the spring seat 185 defined in the sleeve 180.

FIG. 12 illustrates the preferred embodiment pawl extension assembly 250. The assembly 250 is shown in FIG. 12 in conjunction with the pawl 200, in an assembled state as the components typically reside when incorporated in a ratchet device.

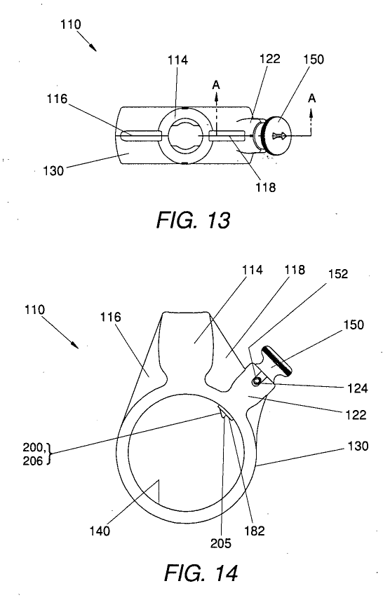

FIGS. 13 and 14 are a planar top view and an elevational side view respectively, of the ratchet assembly shown in FIG. 3. The assembly in FIGS. 13 and 14 is partially assembled such that the pawl 200 and other components such as the springs 170 and 190 (not shown), the sleeve 180 (not shown) are assembled and retained within the pawl access aperture 146 extending within the receiving member 122 of the head 110. FIG. 14 depicts the pawl 200 in an extended position in which the tip 206 is exposed along the interior circumferential surface 140, of the ratchet head 110. An end 182 of the sleeve 180 also extends slightly beyond the surface 140.

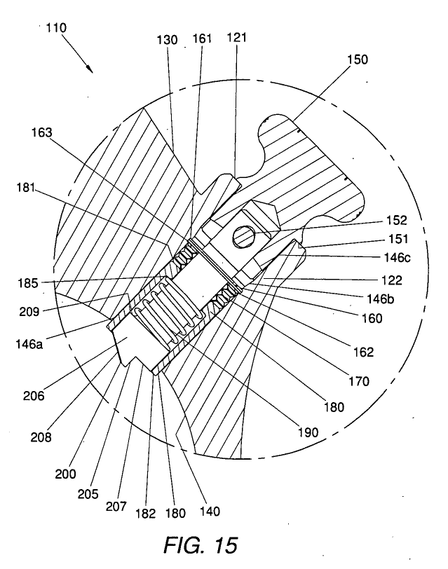

FIG. 15 is a detailed partial cross-sectional view of the assembly of pawl 200, springs 170 and 190, and sleeve 180 disposed within the receiving member 122 of the ratchet head 110. The cross section of FIG. 15 is taken along section line A-A in FIG. 13. FIG. 15 illustrates a preferred configuration and orientation of the preferred embodiment pawl extension assembly. FIG. 15 illustrates the pawl 200 in an extended position. The pawl access aperture 146 extends through the ratchet head 110, and preferably from the interior circumferential surface 140 to the distal support ledge 121 defined along the receiving member 122. The access aperture 146 preferably defines a plurality of differently sized segments or portions such as a segment 146a extending from the surface 140, a segment 146c extending from the support ledge 121, and a segment 146b extending between the segments 146a and 146c. Preferably, each of the segments 146a, b, and c are circular in cross section. Preferably, the diameter of segment 146c is greater than that of segment 146a. And, preferably, the segment 146b provides a relatively smooth transition between segments 146a and 146c, however other configurations are contemplated such as a stepped configuration. Pawl 200 is generally centrally disposed within the pawl access aperture 146 defined within the body 130 of the ratchet head 110. The pawl 200 is preferably oriented within the aperture 146 such that the angled surface 208 defined along the distal tip 206 directly faces adjacent splines (not shown) when a die head is retained within the ratchet head 110. As previously noted, when the pawl 200 is in its extended state, such that the tip 206 is positioned within a region between two adjacent splines, the pin 152 is received and positioned in a lowermost bottom or end region of the retention slot 124 (not shown).

FIG. 15 also illustrates a preferred configuration for the sleeve 180, also disposed within the access aperture 146. The previously noted retaining ring 160 described in conjunction with FIG. 3, is preferably positioned within a receiving depression 161 defined along the interior wall of the access aperture 146. The depression 161 is sized such that the ring 160 can be inserted and retained therein. The washer 162 is preferably positioned immediately adjacent to the ring 160. A lower engagement face 163 is defined along the exposed underside of the washer 162. The preferred embodiment assembly also includes the use of a single ring 160 or washer 162 instead of the use of both. Alternately in certain embodiments, instead of the provision of the retaining ring 160 and the washer 162, a step may be provided along the interior of the pawl access aperture such as by machining or otherwise forming such within the wall of the pawl access aperture 146.

Also disposed within the access aperture 146 is the sleeve 180. As can be seen in FIG. 15, the pawl 200 extends through the hollow interior of the sleeve 180. Disposed within the interior of the sleeve 180, is the spring 190. Preferably, the spring 190 is positioned and preferably compressed between the seat surface 209 of the pawl and the spring seat 185 defined within the interior of the sleeve 180. Preferably, the end of the spring 190 abuttingly contacts the spring seat 185 of the sleeve 180. The compressed state of the spring 190 results in a biasing of the pawl 200 to an extended position into the interior of the body 130 of the ratchet head 110.

Additionally disposed within the access aperture 146 is the spring 170, as depicted in FIG. 15. The spring 170 preferably is positioned between the end 181 of the sleeve 180 and the lower engagement face 163 defined by the washer 162 retained within the access aperture 146.

The preferred embodiment assembly operates as follows. Upon appropriate selection and placement of a die head such as die head 55 depicted in FIG. 2, within the generally open interior of the ratchet head 110 having pawl 200 in a retracted position, the row of splines 44 is approximately aligned with the segment 146a of the access aperture 146 and thus, also aligned with the pawl 200 disposed therein. That is, the die head 55 is positioned within the ratchet head 110 such that the pawl 200 is approximately centered between the circumferential races 43 and 45 defined along the sides of the row of splines 44. Upon extension of the pawl 200 into the interior of the ratchet head 110, the compressed state of the springs 170 and 190 collectively urge the pawl 200 into the interior of the ratchet head 110 and beyond the surface 140. Specifically, the spring 170 urges the sleeve 180 and pawl 200 into the interior of the ratchet head 110 and past the surface 140. And, the spring 190 also urges the pawl 200 with respect to the sleeve 180, into the interior of the ratchet head and past the surface 140. The sleeve 180 is urged between both of the races 43 and 45. The sleeve 180 is also preferably urged to extend below the outer surface of the races 43 and 45, and thus be in close proximity to the outermost radial surfaces of the row of splines 44. The pawl 200 and particularly the tip 206 of the pawl 200 is urged and thus extended into a void or free region between adjacent splines, or the die head may be rotationally positioned within the die head such that a spline contacts the tip 206. Upon full extension of the pawl 200 into the ratchet head 110, the underside 151 of the knob 150 contacts the support ledge 121 defined along the outermost surface of the receiving member 122.

Upon retraction of the pawl 200, a user pulls the knob 150 away from the ratchet head 110 to thereby separate the underside 151 of the knob 150 from the support ledge 121 of member 122. Movement or displacement of the knob 150 is transferred to the pawl 200 by the pin 152. As the pawl 200 is retracted and withdrawn from the interior of the ratchet head 110, the spring 190 is compressed as it is positioned between the seat surface 209 of the pawl 200 and the spring seat 185 of the sleeve 180. As the spring 190 is compressed, the sleeve 180 is also urged within the access aperture 146 such that it is retracted or otherwise withdrawn from the interior of the ratchet head 110 and preferably within the access aperture 146. Preferably, upon full retraction, the end 182 of the sleeve 180 is entirely withdrawn and is positioned beneath the surface 140. Further retraction of the pawl 200 and the sleeve 180 is precluded once the spring 170 is sufficiently compressed between the end 181 of the sleeve 180 and the washer 162, which in turn is immediately adjacent the stationary retaining ring 160.

As previously noted, instead of the retaining ring 160 and washer 162 positioned along the interior wall of the access aperture 146, a step or other ledge can be machined or otherwise formed in the wall of the aperture 146. The present invention includes both strategies.

The preferred embodiment pawl extension assembly 250 and its components can be formed from any suitable material of construction. The pawl 200 and sleeve 180 are preferably formed from metal such as steel. It is contemplated that the sleeve 180 could be formed from one or more plastics. Preferably, the sleeve, and particularly the interior circumferential surface of the sleeve, is relatively smooth and exhibits a low friction characteristic. The springs 170 and 190 are also preferably formed from metal such as steel, however nearly any other material having suitable elastic characteristics could be used. In addition, one or more components of the assembly 250 can be coated or otherwise treated to impart particular characteristics thereto.

Although the present invention and particularly, the pawl extension assembly, has been described in terms of an exposed manual threader, it will be appreciated that the invention includes the incorporation and use of the pawl extension assembly in an enclosed device.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A ratcheting threader drive device comprising:
a ratchet head including a body defining a neck, a pawl receiving member, an outer surface, and an inner circumferential surface, the inner surface defining a hollow interior, the pawl receiving member defining an access aperture extending between the outer surface and the inner surface;
a ratchet ring including a plurality of outwardly extending splines disposed along the circumference of the ring, the ring and plurality of splines sized to fit within the hollow interior of the ratchet head;
a pawl assembly including a pawl having a distal tip adapted to engage the splines of the ratchet ring, at least one biasing member, and a knob engaged to an end region of the pawl opposite the distal tip, the pawl assembly at least partially disposed in the access aperture of the pawl receiving member; and
a sleeve disposed within the access aperture and defining a longitudinal channel through which the pawl extends,

2. The device of claim 1 further including a handle engaged with the neck of the body.

3. The device of claim 1 wherein the biasing member is a spring.

4. The device of claim 1 wherein the at least one biasing member includes two springs.

5. The device of claim 1 wherein the sleeve defines a circular spring seat within the longitudinal channel of the sleeve, and the sleeve and biasing member are in abutting contact with one another.

6. The device of claim 1 wherein the distal tip of the pawl defines a circular and outwardly extending seat surface, the seat surface contacting the biasing member.

7. A ratcheting threader drive assembly comprising:
a ratchet head having (i) a body defining a neck, a pawl receiving member, an outer surface, and an inner circumferential surface, the inner surface defining a hollow region, the pawl receiving member defining an access aperture extending between the outer surface and the inner surface of the body, and (ii) a handle engaged with the neck of the body;
a die head having a ratchet ring including a collection of outwardly projecting splines, the splines arranged in a row around the periphery of the ratchet ring, the ratchet ring and collection of splines adapted to fit within the hollow region of the ratchet head;
a pawl assembly including a cylindrically shaped pawl having a distal end for engaging the collection of splines of the ratchet ring, at least one biasing member, and a gripping member attached at an end of the pawl opposite the distal end, the pawl assembly slidably disposed in the access aperture defined in the pawl receiving member of the ratchet head; and
a sleeve having a first end, a second end opposite the first end, and an aperture extending between the first and second ends, the sleeve disposed within the access aperture defined in the pawl receiving member and the pawl, extending through the aperture of the sleeve.

8. The ratcheting threader drive assembly of claim 7 further comprising:
at least one die engaged to the die head.

9. The ratcheting threader of claim 7 wherein the biasing member is a spring.

10. The ratcheting threader of claim 7 wherein the at least one biasing member includes two springs.

11. The device of claim 7 further comprising a biasing member, wherein the sleeve defines a circular spring seat within the aperture of the sleeve, and the sleeve and biasing member are in abutting contact with one another.

12. The device of claim 7 wherein the distal end region of the pawl defines a circular and outwardly extending seat surface, the seat surface contacting an end of the at least one biasing member.

13. A ratcheting threader drive device comprising:
a ratchet head having a body that defines an outwardly extending neck, a pawl receiving member, an outer surface, and an inner surface defining a hollow interior of the body, the pawl receiving member defining an access aperture extending between the outer surface and the inner surface of the body;
a pawl slidably disposed in the access aperture defined in the pawl receiving member; and
a pawl extension assembly also disposed in the access aperture defined in the pawl receiving member, the pawl extension assembly including (i) a sleeve defining a longitudinal channel extending across the length of the sleeve, and (ii) at least one biasing member in contact with the sleeve, wherein the pawl extends at least partially within the longitudinal channel of the sleeve.

14. The ratcheting threader drive device of claim 13 wherein the sleeve defines a spring seat within the longitudinal channel defined in the sleeve, the pawl extension assembly includes a second spring that also contacts the sleeve.

15. A ratcheting threader drive comprising:
a ratchet head defining an outer surface and an interior surface, the interior surface defining a generally hollow cylindrically shaped interior, the head also including an outwardly projecting pawl receiving member, the head also defining an access aperture extending through the pawl receiving member to the interior of the ratchet head;
a die head having a ratchet ring including a plurality of splines extending about a circumferential region of the die head, the die head sized and adapted to be positioned within the interior of the ratchet head;
a sleeve disposed in the access aperture defined in the ratchet head, the sleeve having a first end and a second end and defining a longitudinal channel extending between the first and second ends; and
a pawl slidably disposed in the access aperture defined in the ratchet head and extending within the longitudinal channel defined in the sleeve, the pawl having a distal tip adapted to extend into the interior of the ratchet head and between adjacent splines of the die head.

16. The ratcheting threader drive assembly of claim 15 further comprising:
a biasing member disposed within the longitudinal channel defined in the sleeve, the biasing member positioned between a spring seat defined along the longitudinal channel of the sleeve and a seat surface defined about an outer region of the pawl.

17. The ratcheting threader drive assembly of claim 16 wherein the access aperture defines a receiving depression, the ratcheting threader drive assembly further comprising:
at least one of (i) a retaining ring and (ii) a washer disposed within the receiving aperture; and
a second biasing member disposed within the access aperture and between the sleeve and one of the retaining ring and the washer.

18. The ratcheting threader drive assembly of claim 17 wherein the pawl extends through the second biasing member and through at least one of the retaining ring and the washer.
